(19) United States
(12) Patent Application Publication
(10) Pub. No.: US 2026/0138534 A1
(43) Pub. Date: May 21, 2026

(54) CAMERA MONITOR SYSTEM WITH TRAILER BLIND SPOT VIEW CONFIGURATION

(71) Applicant: Stoneridge Electronics AB, Solna (SE)

(72) Inventors: Banuprakash Murthy, Novi, MI (US); Troy Cooprider, White Lake, MI (US); Gabriel Lepage, Royal Oak, MI (US)

(21) Appl. No.: 19/230,609

(22) Filed: Jun. 6, 2025

Related U.S. Application Data
(60) Provisional application No. 63/721,007, filed on Nov. 15, 2024.

(51) Int. Cl. B60R 1/27; H04N 7/18

(52) U.S. Cl. CPC B60R 1/27; H04N 7/181; B60R 2300/105; B60R 2300/70; B60R 2300/8026

(57) ABSTRACT

A method of providing views in a camera monitor system (CMS) for a vehicle including a tractor and a trailer includes receiving first and second captured images from first and second cameras that respectively provide first and second fields of view alongside a left side and a right side of the vehicle, the first and second fields of view are other than legally prescribed narrow- or wide-angle views that include the trailer, receiving a third captured image from a centrally located vehicle camera to provide a third field of view in a central blind spot of the vehicle, and simultaneously depicting the first, second and third captured images as discrete, unstitched images on at least one display.

### PRIORITY CLAIM

This application claims priority to U.S. Provisional Application Ser. No. 63/721,007, entitled “METHODS AND SYSTEMS FOR PROVIDING MULTIPLE IMAGE FEEDS ON A DISPLAY IN A CAMERA MONITOR SYSTEM”, filed on Nov. 15, 2024 and incorporated herewith in its entirety.

### TECHNICAL FIELD

This disclosure relates to a camera monitor system (CMS), and more particularly, to a method and apparatus for a CMS displaying trailer blind spots and other blind spots.

### BACKGROUND

Vehicle camera systems for mirror replacement or for supplementing mirror views are utilized in commercial vehicles to enhance the ability of a vehicle operator to see a surrounding environment of the commercial vehicle. Camera monitor systems (CMS) utilize one or more cameras to provide an enhanced field of view to a vehicle operator. In some examples, the mirror replacement systems cover a larger field of view than a conventional mirror, or include views that are not fully obtainable via a conventional mirror.

There is a desire to improve operator visibility to reduce risk. One approach is to add more cameras and more displays to increase the viewable area around the vehicle. This approach is intended to reduce blind spots; however, it is desirable to illustrate those blind spots in a manner that maximizes operator awareness. That is, simply adding more cameras and more displays does not necessarily increase driver awareness if the information is not presented in an intuitive way that can by quickly assimilated by the operator.

### SUMMARY

In one example embodiment, a method of providing views in a camera monitor system (CMS) for a vehicle including a tractor and a trailer includes receiving first and second captured images from first and second cameras that respectively provide first and second fields of view alongside a left side and a right side of the vehicle, the first and second fields of view are other than legally prescribed narrow- or wide-angle views that include the trailer, receiving a third captured image from a centrally located vehicle camera to provide a third field of view in a central blind spot of the vehicle, and simultaneously depicting the first, second and third captured images as discrete, unstitched images on at least one display.

In a further example embodiment of any of the foregoing embodiments, the first and second fields of view respectively correspond to operator and passenger side views from rear-facing trailer mounted cameras.

In a further example embodiment of any of the foregoing embodiments, the third field of view corresponds to a passenger side view of the vehicle from a passenger side tractor corner along a front of the tractor.

In a further example embodiment of any of the foregoing embodiments, the third field of view is a Class VI view.

In a further example embodiment of any of the foregoing embodiments, the third field of view corresponds to a rear-facing view from a rear of the trailer.

In a further example embodiment of any of the foregoing embodiments, the method incudes a step of receiving fourth and fifth captured images respectively from fourth and fifth cameras respectively on the left side and right side of the vehicle. Each of the fourth and fifth cameras provide the legally prescribed narrow- and wide-angle views that include the trailer.

In a further example embodiment of any of the foregoing embodiments, the at least one display includes a driver side display and a passenger side display respectively arranged in proximity to a driver side A-pillar and a passenger side A-pillar. Each of the driver side display and the passenger side display depict the narrow-angle view of the vehicle, and the first and second captured images are depicted as a picture-in-picture view over the displayed narrow-angle views, and the at least one display includes another display depicting the third captured images.

In a further example embodiment of any of the foregoing embodiments, the narrow- and wide-angle views respectively include Class II and Class IV views.

In a further example embodiment of any of the foregoing embodiments, at least one display is provided by a common display. The first, second and third captured images are depicted on the common display.

In a further example embodiment of any of the foregoing embodiments, the common display is a central display that is centrally located in a cabin of the tractor.

In a further example embodiment of any of the foregoing embodiments, the third captured image is depicted between the first and second captured images.

In a further example embodiment of any of the foregoing embodiments, the method includes a step of detecting one of a transmission forward gear and a transmission reverse gear, and the third field of view corresponds to a passenger side view of the vehicle from a passenger side tractor corner along a front of the tractor when in the transmission forward gear, and the third field of view corresponds to a rear-facing view from a rear of the trailer when in the transmission reverse gear.

In a further example embodiment of any of the foregoing embodiments, the first and second captured images are depicted next to one another.

In a further example embodiment of any of the foregoing embodiments, the first and second fields of view respectively correspond to operator and passenger side views from rear-facing tractor mounted cameras capturing aftward along tractor.

In a further example embodiment of any of the foregoing embodiments, wherein the first and second fields of view are Class V views.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera mirror system (CMS) used to provide at least narrow and wide fields of view alongside the vehicle (e.g., Class II and Class IV views).

FIG. 2 is a schematic birds-eye view of the commercial truck of FIG. 1 with a CMS providing, for example, Class II, Class IV, Class V, Class VI, and Class VIII views.

FIG. 3 is a schematic top view of an example vehicle cabin interior.

FIG. 4 is a perspective view of an example vehicle cabin interior.

FIG. 5 illustrates fields of view captured by cameras that are positioned to mitigate operator blind spots FIG. 6A is a schematic view of a left-hand display from FIG. 3.

FIG. 6B is a schematic view of a right-hand display from FIG. 3.

FIG. 7 depicts one example display showing several blind spots to the operator.

FIG. 8 depicts another example display showing several blind spots to the operator.

FIG. 9 depicts still another example display showing several blind spots to the operator.

### DETAILED DESCRIPTION

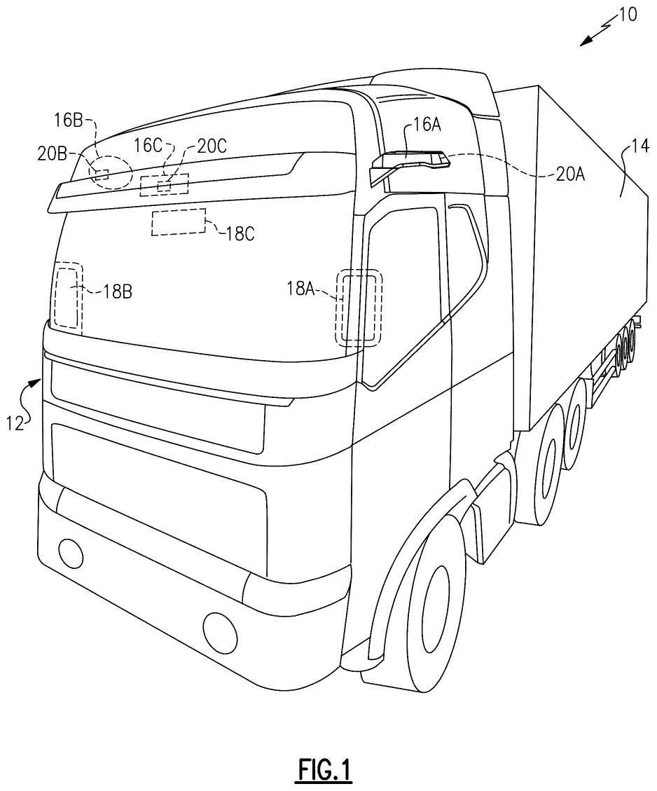

Schematic views of a commercial vehicle 10 are illustrated in FIGS. 1-4. The commercial vehicle 10 includes a vehicle cab or “tractor” 12 for pulling a trailer 14, where the trailer 14 articulates with respect to the tractor 12 during turns. Although the commercial vehicle 10 is depicted as a commercial truck with a single trailer in this disclosure, it is understood that other commercial vehicle configurations may be used (e.g., different types or quantities of trailers).

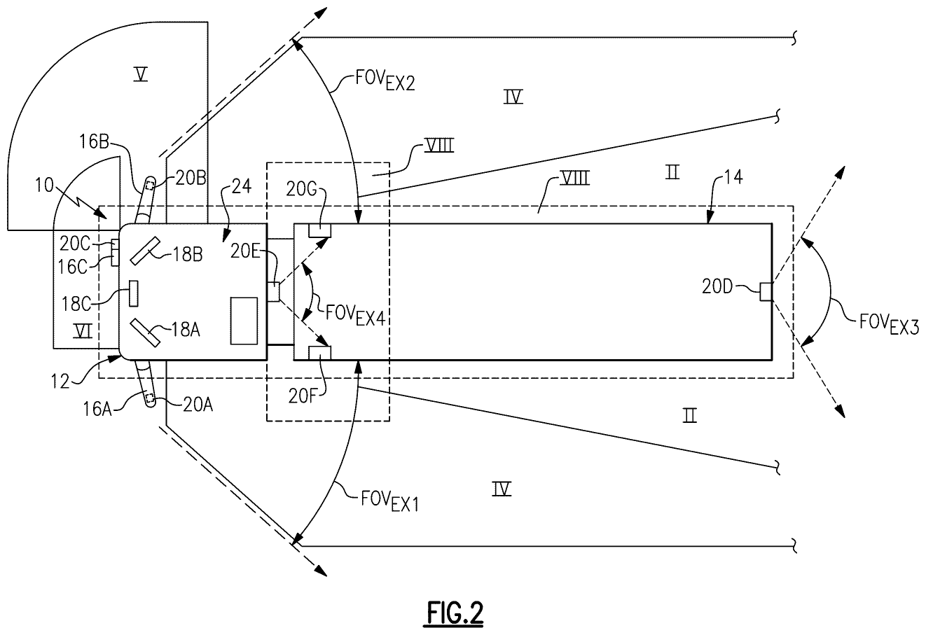

A pair of camera arms 16A-B include a respective base that is secured to, for example, the tractor 12. A pivoting arm is supported by the base and may articulate relative thereto, or the camera arm (or “wing”) may be a fixed, non-pivoting structure. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II (narrow) and Class IV (wide) views (FIG. 2), which are legally prescribed views in the commercial trucking industry.

The Class II view on a given side of the commercial vehicle 10 is a subset of the class IV view of the same side of the commercial vehicle 10. Multiple cameras also may be used in each camera arm 16A-B to provide these views, if desired. Class II (narrow-angle) and Class IV (wide-angle) views are defined in European R46 legislation, for example, and the United States and other countries may have similar driver visibility requirements for commercial trucks. These narrow- and wide-angle views are typically legally prescribed views and include a view of the trailer. Any reference to a “Class” view is not intended to be limiting, but is intended as an example of the type of view provided to a display from a particular camera. For example, certain views may be prescribed in SAE J3155 or other regulations.

Each camera arm 16A-16B may also provide a housing that encloses electronics, e.g., a controller, that are configured to provide various features of the CMS 15. The camera arms 16A-B may be mounted either at a roof-mount location over the cab door (as shown), or on a door-mounted bracket or station, for example. If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

If video of Class V and/or Class VI views is also desired, a camera housing 16C and camera 20C may be arranged at or near the front of the commercial vehicle 10 to provide those views (FIG. 2). Generally, Class V covers a passenger side of the vehicle from a passenger vehicle cab corner aftward along a cab of the vehicle, and Class VI covers a passenger side of the vehicle from a passenger vehicle cab corner along a front of a cab of the vehicle. Separate cameras may be provided to cover the Class V and Class VI view, for example, a camera 20C may be provided in each of the passenger and operator side wings to provide the Class V view.

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The fifth wheel camera 20E may be mounted anywhere between the lateral plane of the fifth wheel fixture and the top/roof edge of the tractor, for example.

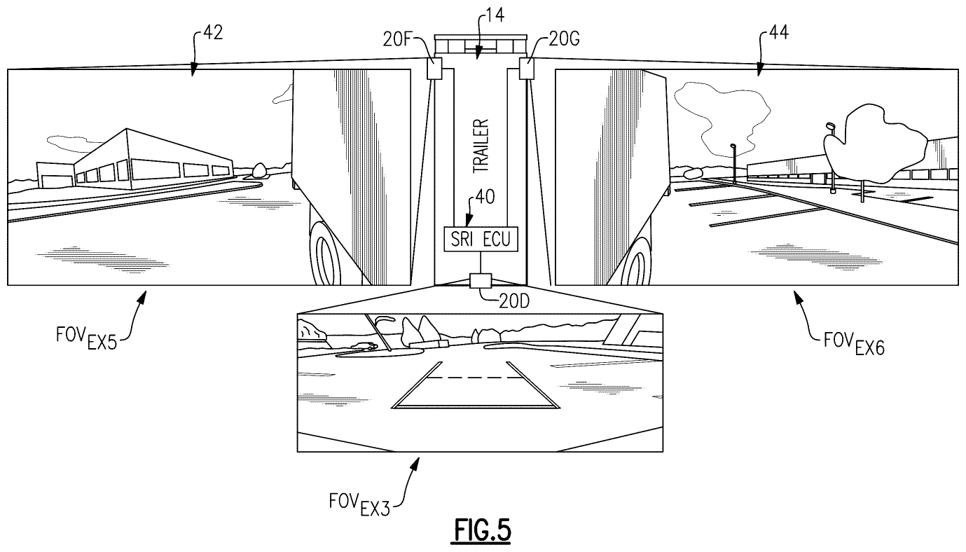

Left- and right-side cameras 20F, 20G may be mounted at the nose of the trailer 14 to provide rear-facing fields of view (FOV_{EX5}, FOV_{EX6}; FIG. 5) along the sides of the trailer 14 for improved operator visibility, particularly during turns during which the trailer 14 is articulated relative to the tractor 12. With continuing reference to FIG. 5, the streaming captured images from the cameras 20D, 20F, 20G are communicated through a controller 40 and then to the tractor. An example of one trailer data communications system is disclosed in United States Publication No. 2024/308,285, entitled “TRAILER CAMERA COMMUNICATIONS SYSTEM”, filed on May 24, 2024 and incorporated herein by reference in its entirety.

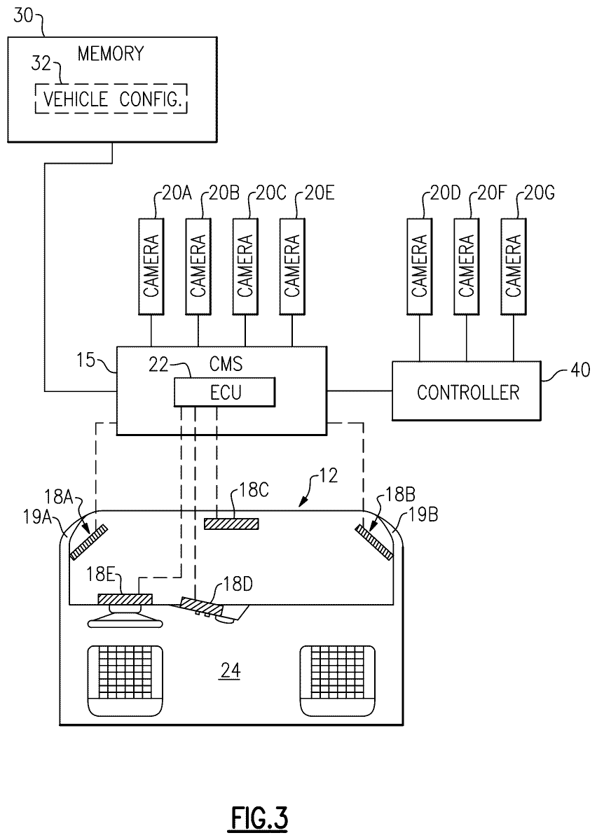

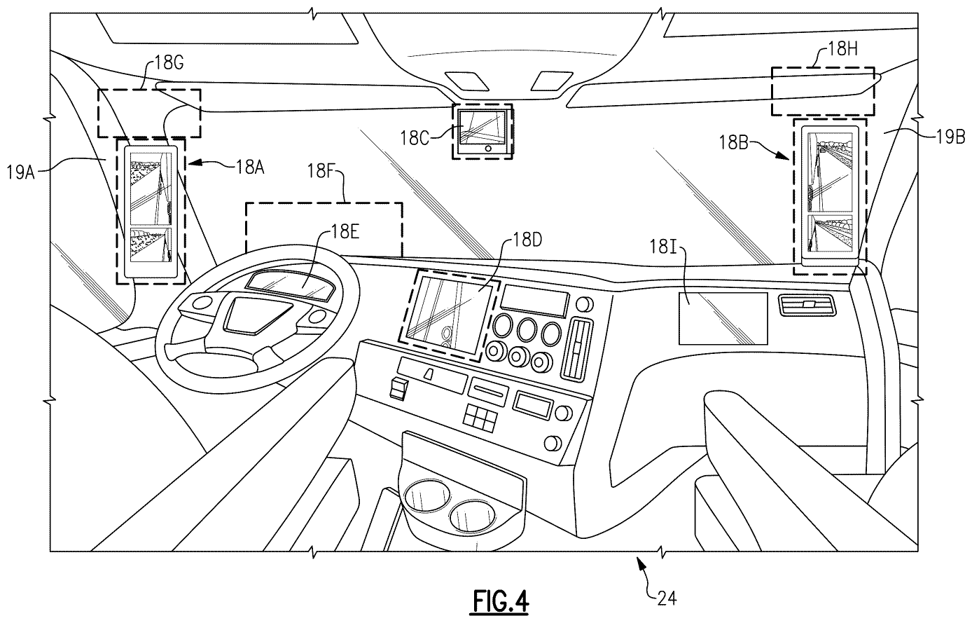

FIG. 3 is a schematic top view of an example vehicle cabin interior 24, and FIG. 4 is a perspective view of the vehicle cabin interior 24. Referring now to FIGS. 3-4 with continued reference to FIGS. 1-2, electronic displays 18A-E (e.g., which may be video displays, such as LCD, OLED displays) and cameras 20A-G are shown. The various electronic displays 18A-E and cameras 20A-G are part of a camera monitor system (CMS) 15, and therefore act as CMS displays and CMS cameras. It should be understood the connections between the various CMS components are shown in a highly schematic manner. As used herein, a “CMS camera” 20 is a camera configured to capture images on an image capture unit of an environment surrounding a commercial vehicle 10 in the camera's field of view, and a “CMS display” 18 is an electronic display (e.g., an LCD, OLED, etc) that is configured to image or display feeds from those cameras (i.e., a live video stream of the captured images).

FIG. 4 illustrates additional or different displays 18F, 18G, 18H, 18I that may be used to display images from the cameras 20A-G or other cameras. For example, display 18F provides a heads-up-display (HUD) projected in the region of the driver side windshield. Displays 18G, 18H may be provided respectively on the A-pillars 19A, 19B to provide additional views to those of the displays 18A, 18B. An additional display 18I may be provided on the passenger side. Fewer, more or different displays and/or configurations may be used.

The CMS 15 includes a CMS controller or electronic control unit (ECU) 22 that acts as a controller and includes processing circuitry that supports operation of the CMS 15. The CMS ECU 22 is operatively connected to memory 30 (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the vehicle cabin interior 24 near the top center of the windshield may be used to display the Class V and Class VI views, which are toward the front of the commercial vehicle 10, or a backup camera view (from camera 20D or 20E) to the driver. Display 18D is provided in a center console area of the vehicle cabin interior 24, generally located centrally in a bottom half of the vehicle cabin, and may be used for other purposes, such as navigation, infotainment, etc (i.e., a secondary information display). Display 18E may be part of an instrument cluster (i.e., a primary information display) located behind the steering wheel, for example.

If video of Class VIII views is desired, camera housings can be disposed at the sides and rear of the commercial vehicle 10 to provide fields of view including some or all of the Class VIII zones of the commercial vehicle 10. In such examples, one of the displays 18C-E may include one or more frames displaying the Class VIII views. The displays 18A, 18B, 18C face a driver region within the vehicle cabin interior 24 where an operator is seated on a driver seat.

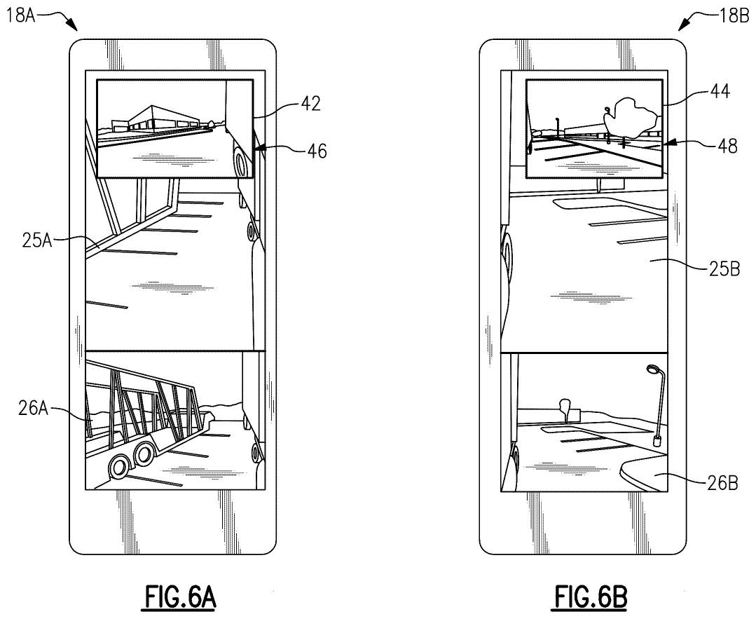

FIG. 6A is a schematic view of the left-hand side display 18A, and FIG. 6B is a schematic view of the right-hand side display 18B. Each display 18A-B includes a respective first display area 25A-B and a respective second display area 26A-B. In the example of FIGS. 6A-B, display area 25A is configured to display a Class II (narrow-angle) view from camera 16A, and display area 26A is configured to display a Class IV (wide-angle) view from camera 16A (or an additional, wide angle camera situated on the same side of the commercial vehicle as camera 16A). Similarly, display area 25B is configured to display a Class II (narrow) view from camera 16B, and display area 26B is configured to display a Class IV (wide) view from camera 16B (or an additional, wide angle camera situated on the same side of the commercial vehicle as camera 16B).

In various examples, the ECU 22 includes one or modules having algorithm(s), equation(s) and/or decision manager(s) that receive input(s) from sensors (e.g., cameras 20A-20E, ultrasonic, LiDar, radar, etc.) and/or stored values. Example inputs include one or more sensors, such as a steering angle sensor, a vehicle speed sensor, gear position sensor, and/or other sensor data, which may be communicated to the CMS 15 over a CAN bus. Vehicle configuration information 32, which may be stored in memory 30, relates to vehicle characteristics (e.g., trailer length, axle position, trailer type/wheelbase, tractor configuration/wheelbase, hitch point location etc.), provided by the manufacturer, operator, and/or determined by one or more of the modules. During vehicle operation, the ECU 22 may communicate information to the driver, fleet operator, or others using an output (e. g, displays 18, speaker, etc.).

While various overlays and alerts may be useful in increasing operator awareness and enhancing safety, it is desirable to more easily and proactively manage awareness of vehicle surroundings. One such approach is to add cameras and displays, if desired, in such a way to increase driver awareness by presenting the captured fields of view in an intuitive way that can be quickly assimilated by the operator.

To improve operator awareness, the CMS 15 receives first and second captured images from first and second cameras (e.g., 20C, 20F, 20G) that respectively provide first and second fields of view (e.g., Class V, FOV_{EX5}, FOV_{EX6}) alongside a left side and a right side of the vehicle. These first and second fields of view are other than legally prescribed narrow- or wide-angle views that include the trailer, that is, other than the FOV_{EX1}/Class VI and FOV_{EX2}/Class II views. In this manner, additional visibility is provided alongside the vehicle, particularly, the trailer, which may be helpful at high trailer articulation angles when panning is limited.

The CMS 15 receives a third captured image from a centrally located vehicle camera (e.g., 20C, 20D, 20E) to provide a third field of view (e.g., Class VI, FOV_{EX3}, FOV_{EX4}) in a central blind spot of the vehicle 10. These three views simultaneously depict the first, second and third captured images as discrete, unstitched images on at least one display. That is, the three views are not combined, for example, to provide a seamless surround bird's-eye-view (BEV). Instead, the three views are presented to the operator in a way this is easily identifiable and reliable and that does not risk losing objects, which can occur when stitching images. The location and configuration of the displayed views can be pre-configured or dynamic based on parameters like turn angle, transmission gear, objects detected, speed, vehicle location (e.g., city vs. highway and tight spot driving, for example.

In the example shown in FIGS. 5, 6A and 6B, the first and second captured images 42, 44 are depicted as picture-in-picture views 46, 48 over the displayed narrow-angle views 25A, 25B. In the context of the three captured images described above, the CMS 15 receives fourth and fifth captured images respectively from fourth and fifth cameras (20A, 20B) respectively on the left side and right side of the vehicle. Each of the fourth and fifth cameras (20A, 20B) provide the legally prescribed narrow- and wide-angle views (Class II and Class IV) that include the trailer 14. In this example, the third captured image is depicted on another display (e.g., 18C, 18D, 18E).

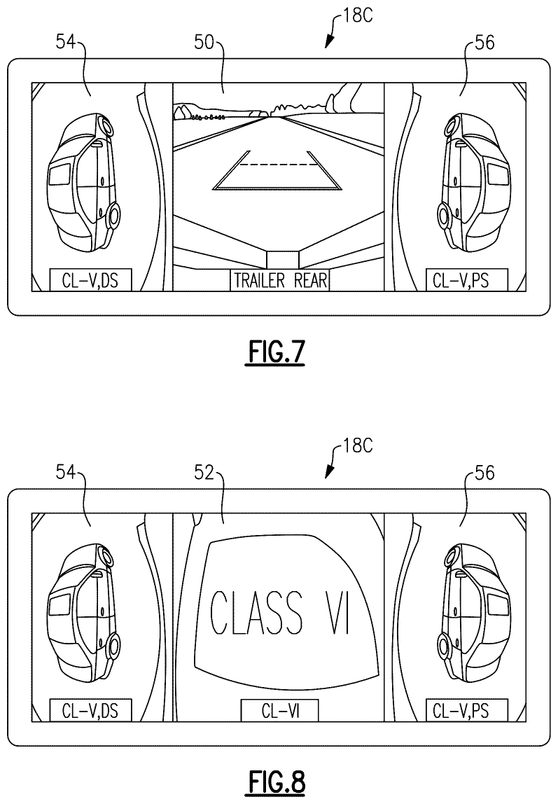

FIGS. 7-9 illustrate examples in which the first, second and third captured images are depicted on a common display, for example, one that is centrally located in a cabin of the tractor 12 (e.g., 18C, 18D). The third captured image is depicted between the first and second captured images to enable the operator to quickly assimilate the views. Referring to FIG. 7, the third field of view corresponds to a rear-facing view (FOV_{EX3}) from the rear of the trailer 14, and the first and second fields of view respectively correspond to operator and passenger side views (Class V) from rear-facing tractor mounted cameras (20C) capturing aftward along tractor 12.

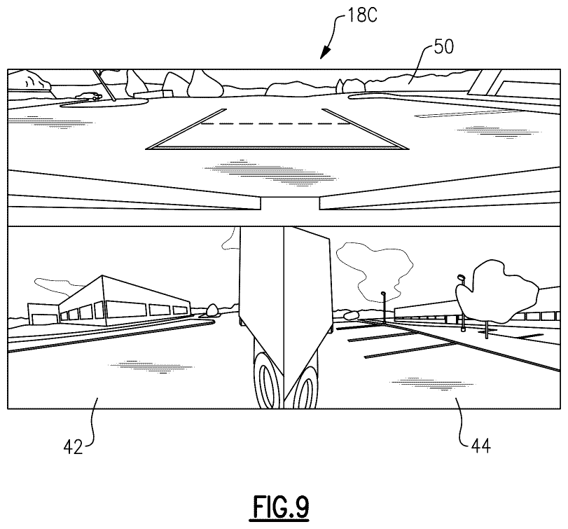

Referring to FIG. 8, the third field of view corresponds to a passenger side view of the vehicle from a passenger side tractor corner along a front of the tractor (Class VI), and the first and second fields of view respectively correspond to operator and passenger side views (Class V) from rear-facing tractor mounted cameras (20C) capturing aftward along tractor 12.

If desired, the common display (e.g., 18C) may switch between the two configurations shown in FIGS. 7 and 8 depending upon the gear position. For example, the CMS 15 can detect one of a transmission forward gear and a transmission reverse gear over the CAN bus. The configuration shown in FIG. 8 is depicted when the transmission is in the forward gear, and the configuration shown in FIG. 7 is depicted when in the reverse gear.

In the example shown in FIG. 9, the first and second captured images (e.g., FOV_{EX4}, FOV_{EX5}) are depicted next to one another, and the third captured image is illustrated above or below the first and second captured images.

The disclosed CMS 15 enables an operator to view and quickly understand more fields of view than the legally prescribed fields of view, particularly during low-speed maneuvering.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

1. A method of providing views in a camera monitor system (CMS) for a vehicle including a tractor and a trailer, comprising:
a) receiving first and second captured images from first and second cameras that respectively provide first and second fields of view alongside a left side and a right side of the vehicle, the first and second fields of view are other than legally prescribed narrow- or wide-angle views that include the trailer;
b) receiving a third captured image from a centrally located vehicle camera to provide a third field of view in a central blind spot of the vehicle; and
c) simultaneously depicting the first, second and third captured images as discrete, unstitched images on a common display.

2. The method of claim 1, wherein the first and second fields of view respectively correspond to operator and passenger side views from rear-facing trailer mounted cameras.

3. The method of claim 2, wherein the third field of view corresponds to a passenger side view of the vehicle from a passenger side tractor corner along a front of the tractor.

4. The method of claim 3, wherein the third field of view is a Class VI view.

5. The method of claim 2, wherein the third field of view corresponds to a rear-facing view from a rear of the trailer.

6. The method of claim 1, comprising a step of receiving fourth and fifth captured images respectively from fourth and fifth cameras respectively on the left side and right side of the vehicle, each of the fourth and fifth cameras provide the legally prescribed narrow- and wide-angle views that include the trailer.

7. The method of claim 6, wherein the at least one display includes a driver side display and a passenger side display respectively arranged in proximity to a driver side A-pillar and a passenger side A-pillar, each of the driver side display and the passenger side display depicting the narrow-angle view of the vehicle, and the first and second captured images are depicted as a picture-in-picture view over the displayed narrow-angle views, and the at least one display includes another display depicting the third captured images.

8. The method of claim 6, wherein the narrow- and wide-angle views respectively include Class II and Class IV views.

9. (canceled)

10. The method of claim 1, wherein the common display is a central display that is centrally located in a cabin of the tractor.

11. The method of claim 1, wherein the third captured image is depicted between the first and second captured images.

12. The method of claim 1, comprising a step of detecting one of a transmission forward gear and a transmission reverse gear;
and wherein the third field of view corresponds to a passenger side view of the vehicle from a passenger side tractor corner along a front of the tractor when in the transmission forward gear, and wherein the third field of view corresponds to a rear-facing view from a rear of the trailer when in the transmission reverse gear.

13. The method of claim 1, wherein the first and second captured images are depicted next to one another.

14. The method of 1, wherein the first and second fields of view respectively correspond to operator and passenger side views from rear-facing tractor mounted cameras capturing aftward along tractor.

15. The method of claim 14, wherein the first and second fields of view are Class V views.
